(19) United States
(12) Patent Application Publication
(10) Pub. No.: US 2016/0111183 A1
(43) Pub. Date: Apr. 21, 2016

(54) Composite Wrapped Steel Tubes for Use in Umbilicals

(71) Applicant: OCEANEERING INTERNATIONAL, INC., Houston, TX (US)

(72) Inventor: Stephen Owen Mast, Cypress, TX (US)

(73) Assignee: OCEANEERING INTERNATIONAL, INC., Houston, TX (US)

(21) Appl. No.: 14/883,219

(22) Filed: Oct. 14, 2015

Related U.S. Application Data
(60) Provisional application No. 62/065,347, filed on Oct. 17, 2014.

(51) Int. Cl. H01B 7/14; G02B 6/44; H01B 13/004; H01B 13/22; H01B 7/20; H01B 13/00

(52) U.S. Cl. CPC H01B 7/14; H01B 7/207; H01B 7/20; H01B 13/0036; H01B 13/004; H01B 13/22; G02B 6/4427

(57) ABSTRACT

Umbilicals may contain one or more steel tubes as well as low and medium voltage electricals and/or fillers, where one or more of the steel tubes comprise both steel and a carbon fiber composite. In an embodiment, the umbilical cable comprises an outer umbilical sheath and one or more signal conduits disposed within the outer umbilical sheath. In an embodiment, the signal conduit comprises a metallic inner wall and a carbon fiber composite outer wall disposed substantially continuously about an outer surface of the metallic inner wall. One or more conductors are typically disposed within the signal conduit. One or more fillers may be disposed about the signal conduit within the outer umbilical sheath.

This application claims the benefit of, and priority through, United States Provisional Application 62/065,347, titled “Composite Wrapped Steel Tubes for Use in Umbilicals,” filed Oct. 14, 2014.

### BACKGROUND

Carbon fiber composites have been used in the pressure vessel industry and have started to be used subsea for subsea pipe and repair. Such uses, however, have been limited to pipe usage rather than tubes for umbilicals.

There is a need for higher pressures to service the higher pressure reservoirs, and subsea equipment is now demanding hydraulic and chemical injection lines up to 20 K psi. Steel tubes to this pressure require the use of more expensive steel, especially as current super duplex steels cannot be manufactured thick enough to meet customer demands. The alternatives have led to the proposed use of Hyper Duplex (SAF 3207), but this is even limited to use less than 1 inch in diameter. Moreover, the wall thicknesses required can make the umbilicals heavy, stiff and expensive to produce.

### FIGURES

Various figures are included herein which illustrate aspects of embodiments of the disclosed inventions.

FIG. 1 is a cutaway view in partial perspective of an illustrative embodiment of a composite wrapped steel tube disposed in an umbilical;

FIG. 2 is a cutaway view in partial perspective of an illustrative embodiment of a composite wrapped steel tube; and

FIG. 3 is a block diagram of an exemplary system for producing a composite wrapped steel tube.

### DESCRIPTION OF EXEMPLARY EMBODIMENTS

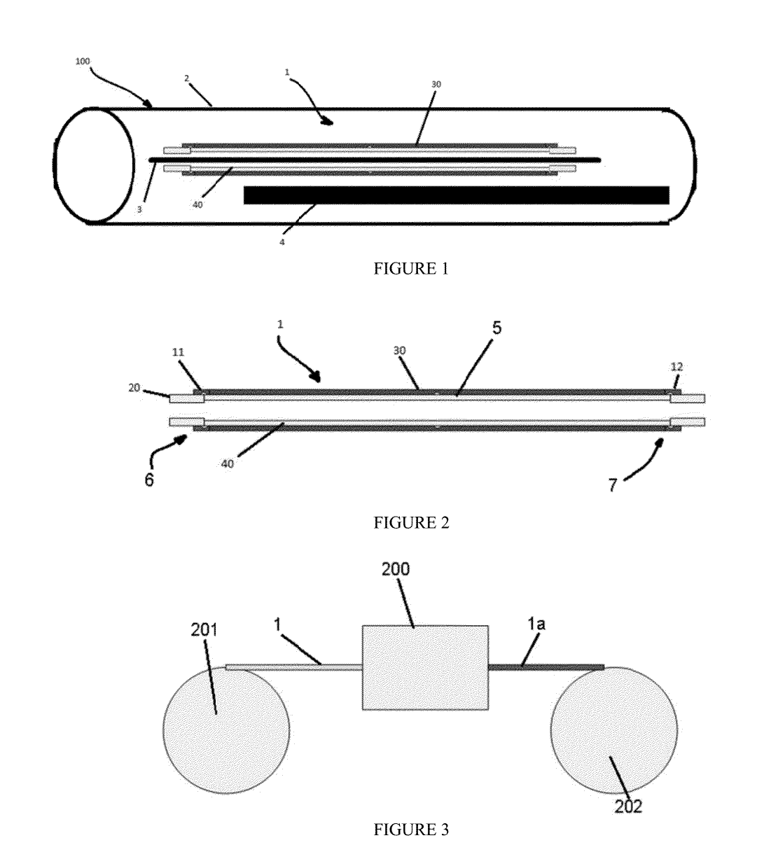

Referring to FIG. 1, in an embodiment umbilical cable 100 comprises outer umbilical sheath 2, one or more conduits 1 disposed within outer umbilical sheath 2; one or more conductors 3 disposed within a first predetermined set of conduits 1; and one or more fillers 4 disposed proximate a predetermined set of conduits 1 within outer umbilical sheath 2. One or more of the conduits 1 may be a signal conduit.

Referring additionally to FIG. 2, each conduit 1 typically comprises metallic inner wall 40 and carbon fiber composite outer wall 30 disposed substantially continuously about outer surface 5 of metallic inner wall 40. As carbon fiber is significantly stronger than steel, it can typically help reduce the outer diameter dimension of and the amount of material used for conduit 1.

Metallic inner wall 40 may comprise a super duplex material, a lean duplex material, a hyper duplex material, or the like, or a combination thereof. In certain embodiments, metallic inner wall 40 comprises steel, by way of example and not limitation such as stainless steel, and, typically, comprises both steel and carbon fiber composite. As a driving design feature for pressure of steel tubes is in the hoop direction, using steel to take up the tensile allows conductors such as fiber can be laid at high lay angles to provide the required hoop strength.

Referring back to FIG. 1, conductors 3 may comprise an electrical conductor, which may be a low voltage electrical conductor or a medium voltage electrical conductor; a fiber optic conductor; or the like; or a combination thereof.

Conduit 1 may further comprise one or more welded, reinforced interfaces 11,12 disposed about one or more ends 6,7 of conduit 1. Typically, interfaces 11,12 are welded and then reinforced by any convenient means, allowing such welds to be inspected and/or X-rayed.

In the operation of exemplary embodiments, referring now to FIG. 3, umbilical cable 100 may be manufactured by providing a predetermined length of conduit 1, which, as descried above comprises a metal, from source 201 to coating station 200 where outer surface 5 of conduit 1 is coated with a carbon fiber in or at coating station 200 to create a substantially continuous composite outer wall disposed about outer surface 5 of conduit 1 and, thereby, create a coated conduit, referred to herein as coated conduit 1a. Coated conduit 1a may be taken up from coating station 200 such as at bobbin 202 after which it may be disposed within outer umbilical sheath 2 of umbilical 100. By way of example and not limitation, a plurality of coated conduits 1a may be disposed within one or more such outer umbilical sheaths 2.

At any convenient time, one or more conductors 3 (FIG. 2) may be disposed within conduit 1. Additionally, at any convenient time, one or more fillers 4 may be disposed within the outer umbilical sheath proximate one or more coated conduits 1a.

Takeup bobbin 202 may be inserted in a cabler and umbilical 100 then built as is common practice for such construction.

The foregoing disclosure and description of the inventions are illustrative and explanatory. Various changes in the size, shape, and materials, as well as in the details of the illustrative construction and/or an illustrative method may be made without departing from the spirit of the invention.

We claim:

1. An umbilical cable, comprising:
a. an outer umbilical sheath;
b. a conduit disposed within the outer umbilical sheath, the conduit comprising:
i. a metallic inner wall; and
ii. a carbon fiber composite outer wall disposed substantially continuously about an outer surface of the metallic inner wall;
c. a conductor disposed within the signal conduit; and
d. a filler disposed proximate the conduit within the outer umbilical sheath.

2. The umbilical cable of claim 1, wherein the metallic inner wall comprises a super duplex material.

3. The umbilical cable of claim 1, wherein the metallic inner wall comprises a lean duplex material.

4. The umbilical cable of claim 1, wherein the metallic inner wall comprises a hyper duplex material.

5. The umbilical cable of claim 1, wherein the metallic inner wall comprises steel.

6. The umbilical cable of claim 1, wherein the conduit further comprises:
a. an end; and
b. a welded, reinforced interface disposed about the end.

7. The umbilical cable of claim 1, wherein the conductor comprises an electrical conductor.

8. The umbilical cable of claim 7, wherein the electrical conductor comprises a low voltage electrical conductor.

9. The umbilical cable of claim 7, wherein the electrical conductor comprises a medium voltage electrical conductor.

10. The umbilical cable of claim 1, wherein the conductor comprises a fiber optic conductor.

11. A method of manufacturing an umbilical cable, comprising:
a. providing a predetermined length of a conduit to a coating station, the conduit comprising a metal sheath;
b. coating an outer surface of the conduit with a carbon fiber in the coating station to create a substantially continuous composite outer wall disposed about the outer surface of the conduit;
c. taking up the coated umbilical conduit from the coating station; and
d. disposing the coated conduit within an outer umbilical sheath.

12. The method of manufacturing an umbilical cable of claim 11, further comprising disposing a conductor within the coated conduit.

13. The method of manufacturing an umbilical cable of claim 11, further comprising disposing a filler within the outer umbilical sheath proximate the conduit.

14. The method of manufacturing an umbilical cable of claim 11, further comprising:
a. providing the conduit with a welded cable interface at an end of the conduit; and
b. reinforcing the welded cable interface.

15. The method of manufacturing an umbilical cable of claim 11, wherein the metal sheath comprises steel.

16. The method of manufacturing an umbilical cable of claim 11, wherein the metal sheath comprises stainless steel.

17. The method of manufacturing an umbilical cable of claim 11, wherein the conduit metal further comprises at least one of a super duplex material, a lean duplex material, or a hyper duplex material.

18. The method of manufacturing an umbilical cable of claim 11, wherein disposing the coated conduit within the outer umbilical sheath comprises disposing a plurality of coated conduits within the outer umbilical sheath.

19. The method of manufacturing an umbilical cable of claim 11, wherein disposing the coated conduit within an outer umbilical sheath comprises disposing a plurality of coated conduits within an outer umbilical sheath.
